(19) United States
(12) Patent Application Publication
(10) Pub. No.: US 2009/0020392 A1
(43) Pub. Date: Jan. 22, 2009

(54) Machining Line for Plate-Type Elements, Particularly Solar Cells, and Method of Machining Plate-Type Elements

(75) Inventors: Ewald KOENIG, Wyhl (DE); Markus HILPERT, Gundelfingen (DE); Klaus MESSMER, March-Holzhausen (DE)

Correspondence Address: CROWELL & MORING LLP;INTELLECTUAL PROPERTY GROUP, P.O. BOX 14300, WASHINGTON, DC, 20044-4300, US

(73) Assignee: THIEME GmbH & Co. KG, Teningen (DE)

(21) Appl. No.: 12/014,451

(22) Filed: Jan. 15, 2008

Related U.S. Application Data
(60) Provisional application No. 60/902,493, filed on Feb. 22, 2007.

(30) Foreign Application Priority Data
Jan. 15, 2007 (DE) 102007003224.4

(51) Int. Cl. B65G 47/22

(52) U.S. Cl. 198/345.2

(57) ABSTRACT

The invention relates to a machining line for plate-type elements, particularly solar cells. According to the invention, a machining station and a positioning station for aligning the plate-type elements relative to a reference point with a predefined position tolerance are provided. The positioning station is connected to the input side of the machining station in the flow direction of the material, and conveying devices are provided for moving the plate-type elements from the positioning station to the machining station while maintaining the predefined position tolerance.

### CROSS-REFERENCE TO RELATED APPLICATIONS

This application claims the benefit under 35 U.S.C. § 119(e) to U.S. provisional patent application Ser. No. 60/902,493 filed Feb. 22, 2007, which in turn claims priority to German Application No. 10 2007 003 224.4, filed Jan. 15, 2007, the entire disclosures of which are hereby incorporated in their entirety.

### BACKGROUND AND SUMMARY OF THE INVENTION

The invention relates to a machining line for plate-type elements, particularly solar cells, having at least one machining station and one positioning station for aligning the plate-shaped elements which is connected to the input side of the machining station in the flow direction of the material. The invention also relates to a process for machining plate-type elements in a production line.

When machining sensitive plate-type elements, such as thin-glass solar cells or so-called string ribbon wafers for solar cells, the risk of breakage during the machining is considerable. For example, in a screen printing station, strip conductors have to be printed onto the solar cells and, during the machining, the mechanical handling of the cells will occasionally damage or even break them. The damaged solar cells or parts of the damaged solar cells may then cause considerable disturbances of the operating sequence, particularly when an industrial production of a high timing rate is involved.

It is an object of the invention to provide a machining line for plate-type elements and a process for machining plate-type elements, whereby an increased process reliability of the implemented machining process can be achieved.

According to the invention, a machining line for plate-type elements, particularly solar cells, is provided which has at least one machining station and one positioning station, which is connected to the input side of the machining station in the flow direction of the material, for aligning the plate-shaped elements relative to a reference point with a predefined position tolerance, and has conveying devices for conveying the plate-type elements from the positioning station to the machining station while the predefined position tolerance is maintained.

By means of the machining line according to the invention, the plate-type elements can be aligned in the positioning station and then, while the predefined position tolerance is maintained, are passed along to the machining station. Another handling of the plate-type elements in the machining station for an alignment in the correct position is thereby avoided, on the one hand, reducing the risk of damaging the plate-type elements and, on the other hand, also permitting a faster machining of the plate-type elements because no additional time is required for the alignment of the plate-type elements in the machining station. The saved time can thereby be utilized for the machining step itself, so that the process reliability can be increased.

As a further development of the invention, the conveying devices have at least a first conveyor belt assigned to the positioning station and a second conveyor belt assigned to the machining station, and suction devices for generating a vacuum in the area of the first and of the second conveyor belt.

After the alignment of the plate-shaped elements in the positioning station, the latter can reliably be held on the conveyor belts by means of a vacuum. Because of this suction effect of the conveyor belts, the plate-shaped elements can no longer slide out of place on the conveyor belts, and a predefined tolerance can also be maintained during the transfer from the first to the second conveyor belt. Specifically, the plate-shaped elements no longer have to be aligned and therefore manipulated on their path from the positioning station to the machining station, so that the risk of damage and therefore the breaking rate will be reduced.

As a further development of the invention, devices are provided for synchronizing the first and the second conveyor belt at least during the transfer of a plate-shaped element from the positioning station to the machining station.

In this manner, it can be ensured that a predefined position tolerance relative to a reference point is also not lost during the transfer from the first conveyor belt to the second conveyor belt because, as a result of the synchronization, no slip occurs between the conveyor belts and the plate-type element.

As a further development of the invention, the first and the second conveyor belt have areas extending transversely to the driving direction, in which areas, a vacuum can be generated for retaining a plate-shaped element by suction, and the first and the second conveyor belt are arranged relative to one another such that, during the transfer of a plate-shaped element from the first to the second conveyor belt, maximally a third of the length of the plate-shaped element situated parallel to the conveying direction is situated outside the areas of the first and second conveyor belt in which a vacuum can be generated.

In this manner, it is ensured that the plate-shaped element is always reliably moved by suction either onto the first or the second conveyor belt and therefore no slip occurs relative to the conveyor belts.

As further development of the invention, several plate-shaped elements, particularly two to eight elements, are arranged side-by-side viewed transversely to the flow direction of the material, and are simultaneously aligned in the positioning station, transferred to the machining station and machined in the machining station.

As a result of such a so-called multiple use, a bottleneck in the machining line is prevented. When, in comparison to a serial machining, five plate-type elements are simultaneously machined side-by-side, while the production output is the same, the time available for the machining of a plate-shaped element is quintupled. This time can be used for machining the plate-type elements as carefully as possible, for example, during screen printing, in order to reduce the breaking rate and increase the process reliability.

As a further development of the invention, the positioning station has at least one stop for aligning the plate-type element, which may, for example, be mechanically constructed such that two mutually opposite stops can be moved toward one another and away from one another by means of a crankshaft and connecting rods. When the axis of rotation of the crankshaft then intersects a central point of a predefined position of a plate-shaped element in the positioning station, a very precise positioning can be achieved in a simple and rapid manner by means of mechanically simple devices. When two pairs of two opposite stops respectively are operated by means of a central crankshaft and connecting rod, a rapid and exact positioning of a plate-shaped element to a central point can take place. In this case, the positioning with respect to the central point is independent of possible differences in size of the individual plate-type elements, because the suggested arrangement of the stops always provides an exact central alignment.

As a further development of the invention, the first conveyor belt assigned to the positioning station has devices for generating an air cushion below a plate-type element.

A plate-type element can be moved on the air cushion at extremely low expenditures of force. As a result, only very low handling forces are required on the plate-type element during the positioning, so that the risk of breakage and generally the risk of damage during the positioning can be considerably reduced. For example, the plate-shaped elements can be moved by means of an air current. Particularly in combination with an air cushion below the plate-shaped element, the plate-shaped elements can then be displaced relative to a reference point by means of simply blowing against them and can thereby be aligned with respect to the latter. In addition or as an alternative, it is, however, for example, also conceivable to incline the first conveyor belt with respect to a material flow plane in order to utilize the resulting slope-down forces for a positioning of the plate-shaped element.

The problem on which the invention is based is also solved by a machining line for plate-type elements, particularly solar cells, having at least one machining station constructed as a screen printing station, in which case, viewed transversely to the material flow direction, several printing positions for one plate-type element respectively, particularly two to eight printing positions, are arranged side-by-side in the screen printing station, a separate printing squeegee being assigned to each printing position.

By providing separate squeegees, the screen printing process for each of the plate-shaped elements arranged side-by-side can be adapted separately. For example, as a result, differences in thickness of the plate-shaped elements to be imprinted can easily be compensated and, in contrast to a common continuous squeegee, it can be avoided that individual plate-shaped elements are exposed to an excessive squeegee pressure. The mechanical stress to the plate-shaped elements during the machining can thereby be made more uniform and in individual cases can be greatly reduced, whereby the process reliability is considerably increased.

As a further development of the invention, a common squeegee bar is provided which spans the printing positions arranged side-by-side and with which the several squeegees are connected. Advantageously, each printing squeegee is connected with the squeegee bar by means of at least two motion elements, particularly pneumatic pressure cylinders.

The providing of a common squeegee bar facilitates the mechanical construction of the screen printing station and, in the case of all printing positions arranged side-by-side, ensures a reliably synchronized printing operation. Because of the fact that each printing squeegee is connected with the squeegee bar by means of pneumatic pressure cylinders, the squeegee pressure can be adjusted separately at each squeegee whereby, for example, the above-mentioned tolerance compensation with respect to the differences in thickness between the individual plate-shaped elements can be achieved.

As a further development of the invention, one separate control unit respectively, particularly a pneumatic pressure regulator, is assigned to the motion elements of each printing squeegee.

In this manner, it can be ensured that, also in the case of numerous printing positions arranged side-by-side, each printing squeegee is lowered at the predetermined pressure onto the plate-shaped element to be imprinted and that differences in the squeegee pressure at the individual printing squeegees do not occur as a result of a common continuous pressure line. Advantageously, the motion elements of each printing squeegee can be controlled separately. In this manner, individual printing squeegees can, for example, be lifted when a printing operation is not required.

As a further development of the invention, the motion elements of each printing squeegee can be controlled as a function of the output signal of at least one sensor for detecting damage to a plate-type element.

In this manner, it can be ensured that wafers recognized to be defective are not imprinted. This measure contributes considerably to the process reliability, because a wafer already recognized to be defective, during the printing step, cannot lead to further contaminations of the machining line but is passed along unmachined. With respect to the printing squeegee, this can easily be achieved in that the printing squeegee is not lowered onto a wafer recognized to be damaged and the latter is therefore not imprinted. In the same manner, naturally also other elements of the screen printing station at the printing position of the wafer recognized to be defective would not be triggered, and, for example, naturally printing ink would not be applied to the printing screen in the case of a wafer recognized to be defective.

As a further development of the invention, a flooding squeegee is assigned to each printing squeegee, the flooding squeegee having a flooding squeegee edge extending transversely to the printing direction, and lateral by-flooders extending from one end of the flooding squeegee edge respectively in the direction of the printing squeegee.

By means of such by-flooders, it can be ensured that the applied printing ink remains within the path defined by the flooding squeegee and assigned to a certain printing position. In the case of several printing positions arranged side-by-side, it can thereby be prevented that printing ink runs from one printing position to the other and therefore has a negative effect on the printing result.

As a further development of the invention, the by-flooders are arranged at an angle of between 90° and 110°, preferably 100°, with respect to the printing squeegee edge and extend particularly at least to the printing squeegee. By adjusting the by-flooders at an angle of approximately 10° toward the outside, dead zones at the transition between the flooding squeegee and the by-flooder can be avoided, which may possibly lead to a deterioration of the printing result. However, the by-flooders may also have sections which at least partially extend diagonally to the printing direction, the sections of adjacent by-flooders overlapping one another viewed parallel to the printing direction in the projection. By means of such diagonally arranged sections, the by-flooders, in the manner of snow plows, can return printing ink into its own path and thereby reliably prevent that printing ink flows over from one printing position to the adjacent printing position.

As a further development of the invention, at least two, in particular, extensible screen hold-down devices are provided in the screen printing station, which screen hold-down devices, in the extended condition or in their operating condition extend approximately to the height of the printing squeegee edge. Viewed in the printing direction, these screen hold-down devices may be arranged on the right or the left of the several printing squeegees.

For a good and reproducible screen printing result, the screen tension is of considerable significance. When now only several printing positions are arranged side-by-side and, for example, the entire right and the entire left printing squeegee cannot be lowered because of recognized damage to plate-type elements during a printing operation, in the case of a printing screen continuing over all printing squeegees, this may result in differences in the screen tension. This is prevented by screen hold-down devices which, irrespective of the position of the printing squeegee, always provide the same conditions for the screen tension.

As a further development of the invention, the positioning station and/or the machining station are equipped with a carrying frame which is arranged to be removable from the machining line transversely with respect to the material flow direction.

For example, such a carrying frame may be arranged so that it can be pulled out of the machining line in a drawer-type manner, for example, for the servicing of the screen printing station. The removability transversely to the material flow direction from the machining line also facilitates the maintenance of the positioning station and/or the machining station in general, because these are necessarily accessible within the machining line only to a limited extent.

As a further development of the invention, the machining station has at least one hot-air fan, by means of which locally limited areas on the plate-type element with the locally limited positions on the plate-type element can be acted upon.

In this manner, for example, only locally imprinted contact surfaces can be dried without a continuous-flow dryer. Thus, for example, each solar cell has two or more locally limited contact surfaces, which are used together with one another for the bonding of the solar cells. These locally limited contact surfaces can be dried in a simple manner by means of a hot-air fan which is significantly easier and more cost-effective than providing a separate continuous-flow dryer.

As a further development of the invention, the machining station is equipped with a movable printing table in order to move a plate-type element deposited on the printing table into a machining station. This permits a precise depositing on the printing table, and subsequently, the printing table can be moved into the printing position without any tolerance deterioration with respect to the position of the plate-shaped element to be machined.

As a further development of the invention, the printing table is provided with a conveyor belt, particularly a paper belt, extending over the printing table surface. In this manner, the printing table surface can be cleaned rapidly and easily in that, for example, a paper belt section with splinters of a broken wafer can be removed and can be replaced by a paper belt section which is situated behind it and is still unused.

The problem on which the invention is based is also solved by a process of machining plate-type elements in a production line having the following steps: Positioning of at least two plate-type elements arranged side-by-side viewed in the material flow direction with a predefined position tolerance in a positioning station, conveying the at least two plate-type elements to a machining station while maintaining the predefined position tolerance by means of conveying devices and machining the at least two plate-type elements in the machining station.

The providing of at least two plate-type elements arranged side-by-side and their simultaneous machining as well as the conveying of the positioned plate-type elements to the machining station while maintaining the position tolerance, considerably increases a process reliability because the handling steps can be saved and, as a result of the so-called multiple use, time is gained for a material-saving machining in the machining station.

As a further development of the invention, a vacuum is generated and the plate-type elements are drawn onto the conveying devices at least during the conveying and machining of the plate-type elements.

As a further development of the invention, an air cushion below the plate-type elements is generated during the positioning.

As a further development of the invention, possible damage to the plate-type elements in the positioning station and/or in the machining station is detected immediately after the conveying of the plate-type elements and the latter are machined or not machined in the machining station as a function of the detected damage to the plate-type elements.

As a result, only those of the several plate-type elements arranged side-by-side in the machining station are machined which were recognized to be without damage. In the case of a screen printing station, this prevents, for example, that a broken wafer is imprinted and that its broken-off splinters together with the printing ink then form residue which is hard to remove and could endanger the entire process.

As a further development of the invention, possible damage to the plate-type elements is detected, and damaged plate-type elements are sorted out as a function of the detected damage, a vacant position resulting from the sorting-out not being filled in the further course of the machining in the machining line.

In this manner, the documentation of the machining process is considerably facilitated because blocks of plate-shaped elements arranged side-by-side are always clocked through the production process as a unit. Although defective plate-shaped elements are sorted out, since resulting vacant positions are not filled, it can still clearly be recognized at the end of the production process from which block of elements arranged side-by-side the just finished elements originate. Naturally, also when vacant positions are filled, the tracking becomes possible in the production process by means of an appropriate computerized detection. However, the expenditures required for this purpose should not be underestimated.

The problem on which the invention is based is also solved by a process for machining plate-type elements in a machining line by which the following steps are provided: positioning and machining of at least two plate-type elements arranged side-by-side in the material flow direction, one machining station being constructed as a screen printing station, detecting of possible damage to the plate-type elements and machining or not machining the plate-type elements in the screen printing station as a function of the detected damage to the plate-type elements.

By means of the process according to the invention, a reaction can take place to possible damage to plate-shaped elements in that such damaged elements are not imprinted. As a result, the process reliability of the entire production process is considerably increased. As a function of the detected damage, expediently, individual printing squeegees, which are each assigned to one of the printing positions arranged side-by-side, are not lowered during the printing operation, and also no printing ink is applied to the corresponding printing position occupied by an element recognized as being damaged.

Additional characteristics and advantages of the invention are found in the following description of preferred embodiments of the invention in combination with the drawings. Individual characteristics of the different embodiments illustrated in the drawings may be arbitrarily combined with one another without exceeding the scope of the present invention.

### BRIEF DESCRIPTION OF THE DRAWINGS

FIG. 1 is a schematic lateral view of a machining line of the invention according to a first embodiment;

FIG. 2 is a top view of the machining line of FIG. 1;

FIG. 3 is a schematic lateral view of a machining line according to a second embodiment of the invention;

FIG. 4 is a top view of the machining line of FIG. 3;

FIG. 5 is a schematic frontal view of a printing unit of the machining lines according to the invention in a first condition;

FIG. 6 is a view of the printing unit of FIG. 5 in a second condition;

FIG. 7 is a top view of several printing squeegees and flooding squeegees of a machining line according to the invention arranged side-by-side;

FIG. 8 is an enlarged representation of a cutout of FIG. 7;

FIG. 9 is a view along Line VIII-VIII of FIG. 8; and

FIG. 10 is a top view of a flooding squeegee according to another embodiment of the invention.

### DETAILED DESCRIPTION OF THE DRAWINGS

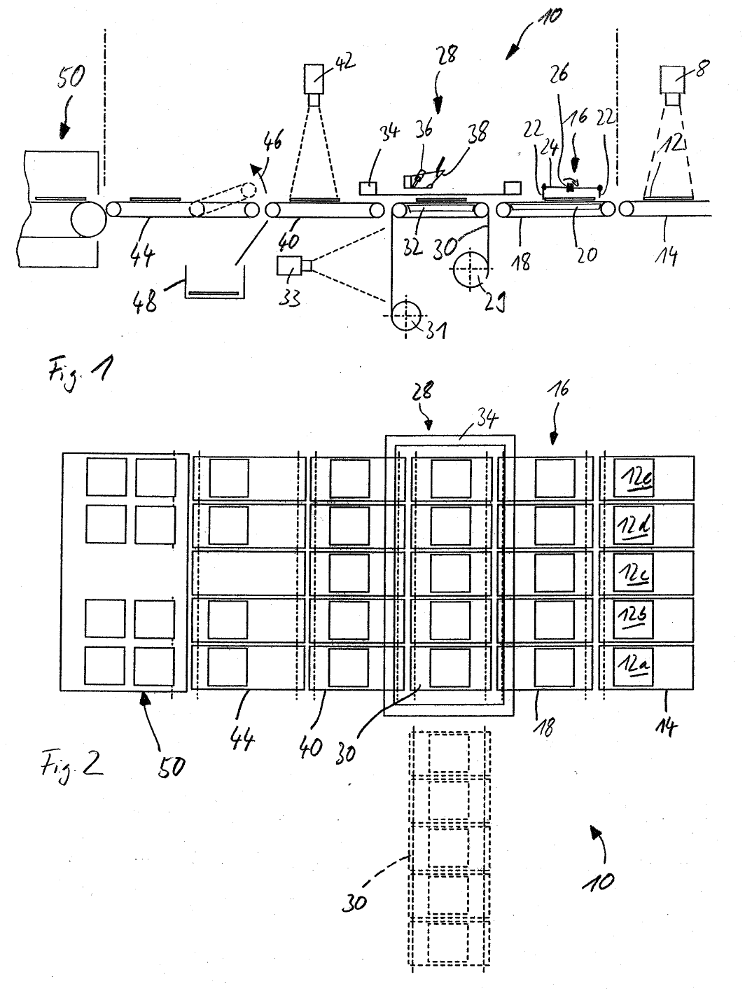

FIG. 1 is a schematic lateral view of a machining line 10 of the invention according to a first embodiment of the invention. Solar cell wafers 12 are supplied by means of a conveying section disposed on the input side, are checked for damage by means of a camera 8 and machining software connected on the output side, the camera 8 generally forming a sensor, and in the area of a positioning station 16, are positioned relative to a reference point. The positioning station has a first conveyor belt 18 equipped with devices 20 for generating a vacuum in the area of the carrying run of the conveyor belt 18 on which the solar cell wafers come to rest. In addition to a vacuum, the device 20 may also generate an air cushion below the wafers 12 in order to be able to displace and position the wafers 12 relative to the conveyor belt 18 at expenditures of force which are as low as possible. For the positioning of the wafers 12, four stops 22 are provided of which only two are illustrated in FIG. 1. By means of connecting rods 24, the stops 22 are each connected with a central crankshaft 26 whose axis of rotation coincides with a reference point for the positioning. When the crankshaft 26 is rotated, the stops 22 are therefore moved toward the crankshaft 26 or away from it. As a result of the rotation of the crankshaft 26, the stops can thereby be moved onto the wafers 12 and then position the latter in two directions arranged perpendicular with respect to one another. If, during the moving of the stops, an air cushion 12 is simultaneously generated below the wafers 12, the positioning can take place at very low forces applied to the wafers 12, so that the risk of damage to the wafer is reduced considerably.

As an alternative, for the positioning, an air cushion can be generated below the wafer 12 and then an air current can be generated by means of nozzles in order to blow the wafer 12 against one or more stops and thereby align it. As another alternative, the conveyor belt 18 can be inclined in order to cause a down-slope force to be applied to the wafer 12 and thereby be able to position it.

After the wafer 12 has been aligned on the first conveyor belt 18 with a predefined position tolerance, the devices 20 are triggered to generate a vacuum and to immovably hold the wafer 12 relative to the conveyor belt 18. The conveyor belt 18 is then caused to move, so that the wafer 12 is moved into the area of a screen printing station 28. The screen printing station 28 has a second conveyor belt 30 and is equipped with devices 32 in order to generate a vacuum in the area of a carrying run of the conveyor belt 30 and thereby hold a wafer 12 immovably in a printing position. During the transfer of a wafer 12 from the first conveyor belt 18 to the second conveyor belt 30, the devices 20 as well as the devices 32 generate a vacuum, and furthermore a movement of the first conveyor belt 18 and of the second conveyor belt 30 is synchronized, so that no slip between the conveyor belts 18, 30 and the wafer 12 occurs during the transfer of a wafer. As a result, it becomes possible to maintain a position tolerance, which was achieved during the positioning on the first conveyor belt 18 relative to a reference point, during the transfer to the second conveyor belt 30. Another positioning in the screen printing station 28 can therefore be eliminated because the conveyor belts 18, 30 are moved only synchronously with one another and thereby convey the wafer 12 into the screen printing station 28.

In the screen printing station 28, the time for another positioning of the wafer 12 is therefore saved, and this gained time will be available for the actual printing operation. Because of the gained time, the printing operation can be coordinated such that the mechanical stress to the wafer 12 is as low as possible, and the risk of a breaking of the wafer 12 is significantly reduced. Another reduction of the breaking risk of the wafer 12 had already been achieved by the fact that no new positioning is required, and therefore no new handling of the wafer 12 is necessary.

In a known manner, the screen printing station 28 is equipped with a printing screen 34 which, together with a printing squeegee 36 and a flooding squeegee 38, is a component of the printing unit, whose other components are not shown in FIG. 1 for reasons of clarity.

After the imprinting of the wafer 12 in the screen printing station 28, the wafer 12 is transferred from the second conveyor belt 30 to a third conveyor belt 40, in which case the position accuracy, if possible, is maintained also during the transfer from the second conveyor belt 30 to the third conveyor belt 40. In the area of the conveyor belt 40, a visual checking of the wafer 12 takes place with respect to the printing quality and possible damage by means of a camera 42 and suitable machining software connected to the output side. If it is recognized by means of the camera 42 that the wafer 12 is damaged or that its imprinting is faulty, the wafer 12 is sorted out in an area of a fourth conveyor belt 44 connected on the output side which is folded upward according to the arrow 46 in FIG. 1 and, as a result, the wafer is conveyed from the conveyor belt 40 directly into a reject container 48. In contrast, if the checking by means of the camera 42 had a positive result, the wafer 12 is transferred from the third conveyor belt 40 to the fourth conveyor belt 44 and, from there, is guided, for example, to a continuous-flow dryer 50.

In the screen printing station 28, the second conveyor belt 30 is constructed as a paper belt and can be used for conveying the wafer 12 as well as for the free printing of the printing screen 34. In the area of the printing table, a circulating additional conveyor belt is provided below the paper belt, which circulating additional conveyor belt is moved synchronously with the paper belt. If, for example, a wafer 12 is damaged during the imprinting in the screen printing station 28, splinters of the wafer may adhere to the printing screen 34. For cleaning the printing screen, the latter is printed free in that a printing operation is carried out without an in-between wafer directly onto the paper belt 30. The then imprinted section of the paper belt 30 is wound onto the roller 31. After each printing operation, the second conveyor belt 30 is moved along anyhow in order to convey the wafer 12 onto the third conveyor belt 40. The section originally situated below the printing screen 34 will then come to be situated in the viewing range of a checking camera 33 and will be checked for damage by means of the camera 33 and machining software connected to the output side. If the check shows that the section of the paper belt 30 is damaged because, for example, splinters of a broken wafer are adhering to it, this paper belt section will no longer be moved back under the printing screen 34, but the new paper belt section from the roller 29, which paper belt section is already situated below the printing screen 34, will now remain in this position and will be used as the base for a new wafer 12 to be imprinted. In contrast, if the checking by means of the camera 33 indicates that the paper belt section previously situated below the printing screen 34 is clean and undamaged, the latter is moved back into the position below the printing screen 34 and can then be used again as a base for a wafer 12 during a screen printing operation. In this manner, it can, on the one hand, be ensured that a clean undamaged printing table surface is always provided by means of the paper belt 30 and, on the other hand, the paper consumption can be reduced because sections of the paper belt 30 are always only disposed of when they are actually dirty or damaged.

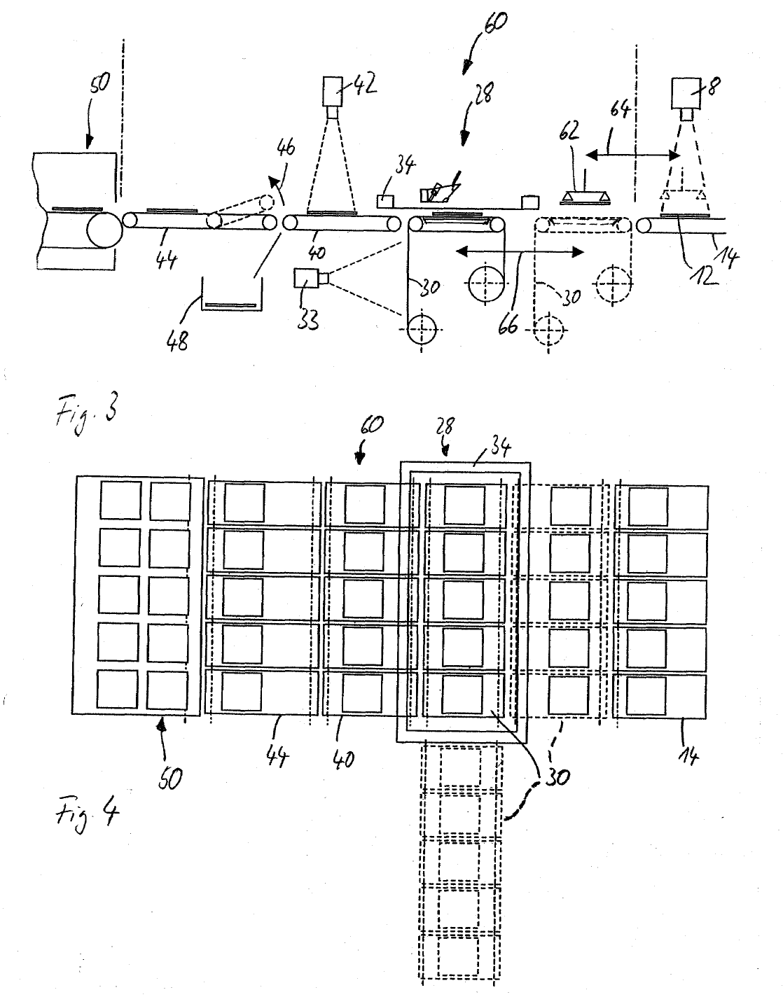

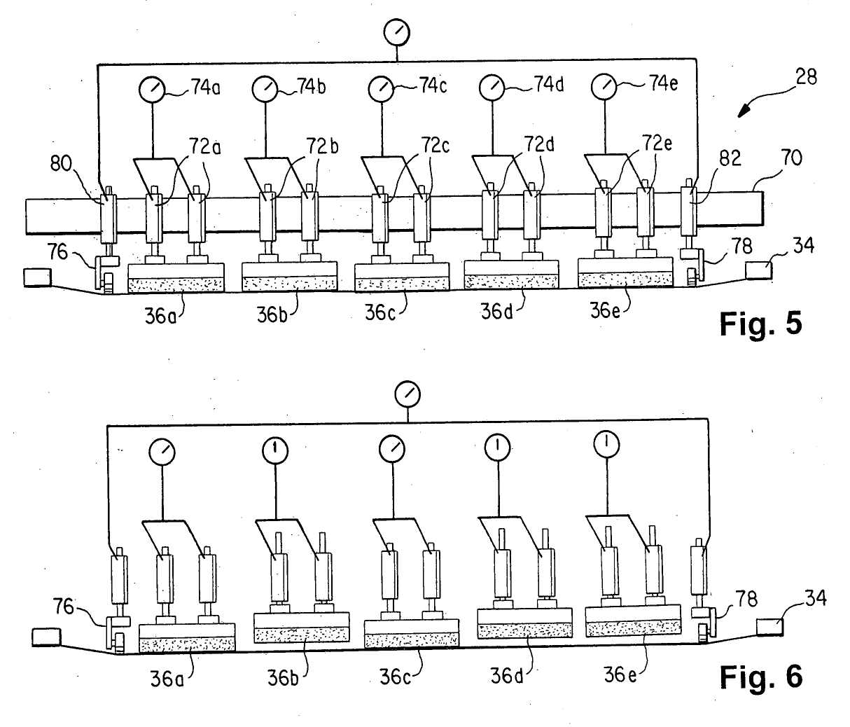

FIG. 2 is a schematic top view of the machining line 10 of FIG. 1, the printing squeegees 36 and the flooding squeegees 38 in the area of the screen printing station 28 not being shown. These will be explained in greater detail by means of FIGS. 5 to 9.

FIG. 2 clearly illustrates that five wafers 12a, 12b, 12c, 12d and 12e situated side-by-side are simultaneously machined in the machining line 10. As a result of this so-called multiple use, time is gained during the machining and, in particular, a bottleneck as a result of the imprinting in the screen printing station 28 can be prevented.

It is also clearly illustrated that five first conveyor belts 18 arranged side-by-side are arranged in the area of the positioning station 16 and five second conveyor belts 30 arranged side-by-side are arranged in the screen printing station 28. They are followed in the same manner by five third conveyor belts 40 arranged side-by-side and five fourth conveyor belts 44. The continuous-flow dryer 50 is also suitable for simultaneously accommodating five wafers 12 arranged side-by-side.

If it is detected by means of the camera 8 in the area of the conveying device 14 that one of the wafers 12a, 12b, 12c, 12d or 12e is damaged, the screen printing station 28 is triggered such that the printing squeegee assigned to this damaged wafer is not triggered and this damaged wafer is not imprinted and is only passed along. In the example of FIG. 2, the wafer 12c, for example, was recognized as being damaged, and this wafer will then not be imprinted in the screen printing station 28 but, as described, in the transition area between the third conveyor belt 40 and the fourth conveyor belt 44, will be transferred out into the reject container 48. The resulting vacant position will also not be filled in the further course of the machining, but blocks of wafers arranged side-by-side are maintained unchanged during the entire machining process. The documentation and tracking of the production conditions for individual wafers is thereby facilitated.

An alternative position of the conveyor belts 30 is indicated in FIG. 2 by a broken line. The conveyor belts 30, which form part of the respective printing tables, can be moved out, together with all five printing tables arranged side-by-side, perpendicular with respect to the material flow direction, from the machining line into the position shown by a broken line in FIG. 2. For this purpose, all printing tables are arranged on a common carrying frame which can then be pulled out of the machining line in a drawer-type fashion. This considerably facilitates the maintenance of the printing tables. For example, in this pulled-out position, the rollers 29, 31 can be exchanged without any problem in order to provide the respective printing table with a new unused paper belt 30.

FIG. 3 is a schematic lateral view of a machining line 60 according to another embodiment of the invention. In this case, components having the same construction as those of machining line 10 in FIG. 1 are provided with the same reference numbers and will not be explained again.

The wafers 12 supplied by the conveying section 14 disposed on the input side are checked for damage by the camera 8 and are removed from the conveying section 14 by means of a so-called pick-and-place device 62. The wafers are aligned relative to a reference point on the pick-and-place device 62 and, in the aligned condition, are then deposited on the paper belt 30. For this purpose, the pick-and-place device 62 can be moved along the double arrow 64 illustrated in FIG. 3 as well as perpendicularly thereto, thus toward the paper belt 30 and away from it. Each wafer 12 is therefore deposited in the already aligned condition on the paper belt 30 and is then moved, together with the paper belt 30, along the double arrow 66 into a position below the printing screen 34 in the printing screen station 28. For this purpose, the printing table with the paper belt 30, together with the rollers 29, 31, can be moved along the double arrow 66, the devices for moving the printing table being designed such that a position accuracy reached after the depositing of the wafer 12 on the paper belt 30 in the position illustrated by a broken line is maintained during movement, and the wafer thereby comes to rest in the exactly predefined position and with the given position tolerance in the screen printing station 28.

As illustrated in FIG. 4, the machining line 60 is also provided for the generally parallel machining of five wafers 12 situated side-by-side. In this case, the five printing tables arranged side-by-side, which each have a paper belt 30, can take up not only the position illustrated in FIG. 3 by a broken line and thus can be moved parallel to the material flow direction along the double arrow 66, but, together with the paper belts 30, can also be pulled in a manner of drawers transversely to the material flow direction out of the machining line 60. As explained in FIGS. 1 and 2, for this purpose, the printing tables, together with the paper belts 30, are fastened on a common carrying frame which can be pulled out.

FIG. 5 is a schematic frontal view of a printing unit of the screen printing station 28. The screen printing station 28 has a squeegee carrier 70 which completely spans the common printing screen 34 and on which five printing squeegees 36a, 36b, 36c, 36d and 36e are arranged side-by-side. Each of the printing squeegees 36a, 36b, 36c, 36d and 36e is assigned to a separate machining path, and each of the five wafers 12a, 12b, 12c, 12d and 12e arranged side-by-side is therefore imprinted by means of a separate printing squeegee 36a, 36b, 36c, 36d and 36e, respectively. In contrast, the printing screen 34 is provided jointly for all five printing positions arranged side-by-side. The use of a common printing screen 34 for several printing positions arranged side-by-side has the result that, for achieving a desired printing accuracy, not the printing screen can be aligned with the object to be imprinted, but rather the individual objects to be imprinted have to be aligned relative to the printing screen. As a result of the invention, the alignment within the screen printing station can be eliminated, thereby saving time and achieving a more careful handling of the elements to be imprinted.

For treating the individual elements to be imprinted as carefully as possible, each printing squeegee 36a, 36b, 36c, 36d, 36e is connected by means of two pneumatic pressure cylinders 72 respectively with the common squeegee bar 70. Furthermore, the two pneumatic pressure cylinders assigned to one printing squeegee respectively are each equipped with a separate pressure regulator 74a, 74b, 74c, 74d and 74e. The pneumatic pressure at each of the printing squeegees 36a, 36b, 36c, 36d and 36e can therefore be adjusted and regulated separately from one another. As a result, it is not only possible to lift and lower each of the printing squeegees 36a, 36b, 36c, 36d and 36e separately from one another, in addition, the contact pressure of the respective printing squeegee 36a, 36b, 36c, 36d and 36e can also adjusted and regulated separately. For the purpose of achieving process conditions which are as uniform as possible for wafers arranged side-by-side, the separate pressure regulators ensure that all printing squeegees act upon the wafers with the same contact pressure respectively.

Since each of the printing squeegees 36a, 36b, 36c, 36d and 36e is pressed on by means of separate pressure cylinders 72a, 72b, 72c, 72d, 72e and, furthermore, each has a separate pressure regulator 74, a tolerance compensation in the thickness of the elements to be imprinted can also be achieved without any problem. For this purpose, separate pressure regulators are not prerequisite, but the separate pressure regulators 74a, 74b, 74c, 74d, 74e can ensure that line lengths, line cross-sections, mechanical and/or pneumatic losses or the like play no significant role with respect to the uniform action upon the elements to be imprinted.

FIG. 5 also illustrates a left screen hold-down device 76 and a right screen hold-down device 78 which are each connected by means of a pressure cylinder 80 and 82 respectively with the common squeegee carrier 70. The two pressure cylinders 80, 82 can be jointly triggered, so that, depending on the requirement, the screen hold-down devices 76, 78 can be moved toward the printing screen 34 and away from the latter. The two screen hold-down devices 76, 78 each have one contact pressure roller respectively which roll on the printing screen 43 during the movement of the squeegee carrier 70. By means of the two screen hold-down devices 76, 78, a uniform screen tension can be achieved, irrespective of whether the individual printing squeegees 36a, 36b, 36c, 36d and 36e are in their lower or lifted position during a printing operation.

As explained above, wafers recognized as being damaged are not imprinted in the case of the machining line according to the invention. For this purpose, the printing squeegees above the wafer detected to be damaged are not lowered. A corresponding condition of the screen printing station is schematically illustrated in FIG. 6. As illustrated, only the printing squeegees 36a and 36c are lowered and therefore rest against the printing screen 34, but the printing squeegees 36b, 36d and 36e are situated in a lifted position, so that they do not touch the printing screen 34, and wafers situated below the printing squeegees 36b, 36d and 36e are therefore not imprinted. In this condition illustrated in FIG. 6, the screen hold-down devices 76, 78 ensure that the same tension of the printing screen 34 exists as in the condition of FIG. 5, in which all printing squeegees 36a, 36b, 36c, 36d and 36e rest on the printing screen 34. Irrespective of the position of individual printing squeegees 36a, 36b, 36c, 36d and 36e, a constant printing quality can therefore always be ensured according to the invention.

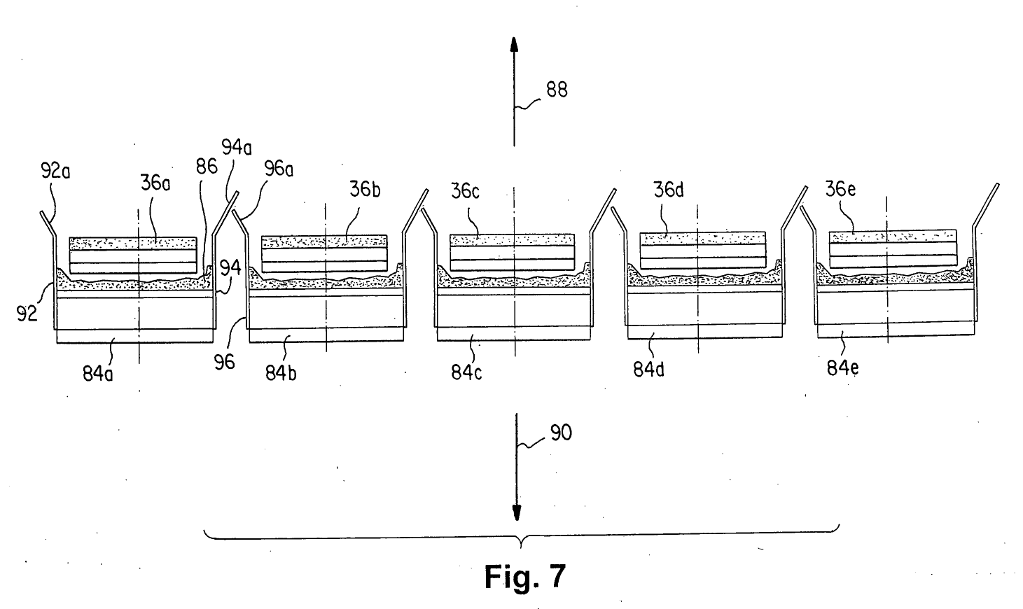

FIG. 7 is a top view of five printing squeegees 36a, 36b, 36c, 36d and 36e of a screen printing station arranged side-by-side. A flooding squeegee 84a, 84b, 84c, 84d, 84e is assigned to each printing squeegee 36a, 36b, 36c, 36d and 36e, which flooding squeegee 84a, 84b, 84c, 84d, 84e ensures a uniform distribution of the printing ink 86 on the printing screen during the flooding of the printing screen. During a movement of the flooding squeegees 84a, 84b, 84c, 84d, 84e, the printing ink is distributed along the arrow 88 over the printing screen. In contrast, the printing direction—thus, the direction in which the printing squeegees 36a, 36b, 36c, 36d and 36e move over the printing screen during the actual printing operation—is the opposite, specifically along the arrow 90.

Each of the flooding squeegees 84a, 84b, 84c, 84d, 84e is aligned perpendicular to the flood direction 88 and to the printing direction 90 respectively and is provided at both ends of a flooding squeegee edge with so-called by-flooders 92, 94, 96. In the example of the flooding squeegee 84a, the by-flooders 92, 94, 96 extend parallel to the flood direction 88 and the printing direction 90 respectively, starting out from the left and the right end respectively of the flooding squeegee 84a. The by-flooders 92, 94, 96 are used for keeping the printing ink 86 during the flooding within a path defined by the by-flooders 92, 94, 96 and thereby preventing that printing ink 86 flows over to an adjacent path of the flooding squeegee 84b and there possibly causes an excess of ink and thereby an impaired printing result. In order to avoid the overflowing of printing ink 86 between the individual paths of the flooding squeegees 84a, 84b, 84c, 84d, 84e, the by-flooders 92, 94 are additionally provided approximately at the level of the printing edge of the printing squeegee 36a with sections 92a, 96a arranged diagonally to the flooding direction 88 and to the printing direction 90 respectively. The two diagonally arranged sections 92a, 94a are both arranged to be opening from a center of the flooding squeegee 84a toward the outside so that, during a movement of the flooding squeegee 84a in the flooding direction 88, they return the ink situated on the printing screen in the manner of a snow plow into the area between the by-flooders 92 and 94. The diagonally arranged section 96a on the by-flooder 96 has a longer construction than the diagonally arranged section 94a on the by-flooder 94, so that, viewed in the flooding direction 88, it overlaps the diagonally arranged section 96a on the by-flooder 96, which is assigned to the flooding squeegee 84b. As a result, it is prevented that a strip of printing ink remains between the two diagonally arranged sections 94a, 96a. Instead, the construction and arrangement of the diagonally arranged sections 94a, 96a on the by-flooders 94 and 96 respectively ensures that an area between the flooding squeegees 84a, 84b, 84c, 84d, 84e is always evacuated completely from printing ink that may possibly have remained there.

As illustrated in FIG. 7, the by-flooders 92, 94, 96 have the same construction on all flooding squeegees 84, 84b, 84c, 84d, 84e, so that always the diagonally arranged section 94a of the respective right by-flooder 94 overlaps the diagonally arranged section 96a of the respective left by-flooder 96 of the adjacent flooding squeegee.

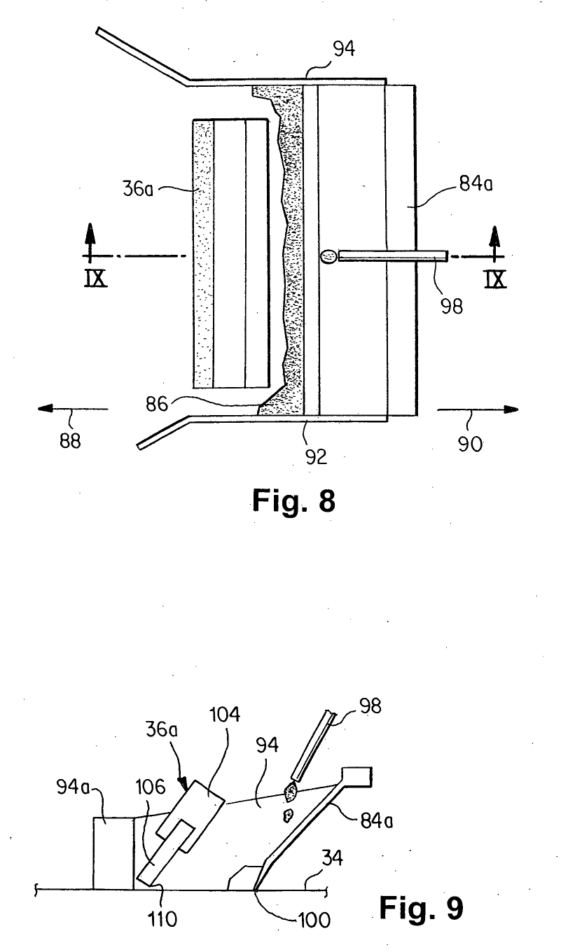

FIG. 8 is an enlarged view of the flooding squeegee 84a of FIG. 7, in addition to the printing squeegee 36a, a feeding pipe 98 for the printing ink 86 being outlined. The feeding pipe 98 for the printing ink 86 is situated in the center of the flooding squeegee 84a so that the printing ink is uniformly distributed to both sides of the flooding squeegee 84a.

FIG. 9 is a view of the cutting plane VIII-VIII of FIG. 8. The shape of the flooding squeegee 84a is easily visible and forms a sloping plane to which printing ink is applied from the feeding pipe 98, then slides downward along this sloping plane and is distributed over the printing screen 34 by a second section of the flooding squeegee arranged steeper with respect to the first section. As described above, the by-flooders 94 with the diagonal sections 94a ensure that the ink is collected during the flooding along the flooding direction 88 and is returned into the area in front of a flooding squeegee edge 100.

The printing squeegee 36a consists of a squeegee holder 104 and of a squeegee rubber device 106 which is aligned to be slanted with respect to the printing screen, so that, in the printing direction 90, it touches the printing screen 34 only by means of its lower edge 110.

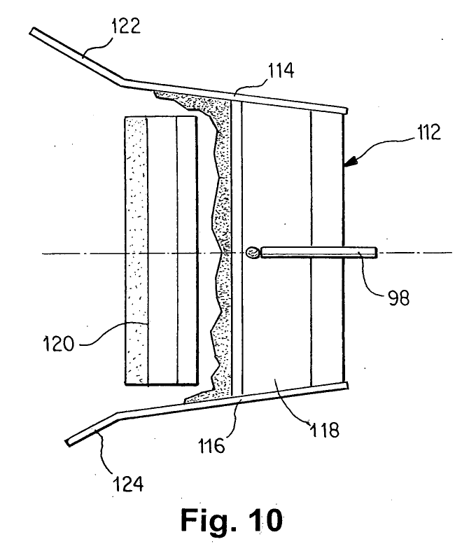

FIG. 10 is a top view comparable to the view of FIG. 8 of a flooding squeegee 112 according to another preferred embodiment of the invention. In contrast to the flooding squeegee 84a of FIG. 8, the flooding squeegee 112 has by-flooders 114, 116 which are not set perpendicular to the flooding squeegee edge 118 but slightly toward the outside with respect to the latter. Advantageously, by-flooders 114, 116 are set at 10° toward the outside, so that they each enclose an angle of approximately 100° with the flooding squeegee edge 118. As a result of this arrangement of the by-flooders 114, 116 set slightly toward the outside, it can be avoided that dead zones form at the transition between the by-flooders 114, 116 and the flooding squeegee edge 118, in which dead zones the printing ink is held. Such dead zones could possibly contribute to the deterioration of the printing result. By means of the slightly set-out arrangement of the by-flooders 114, 116 according to FIG. 10, it can be ensured that the printing ink collected by the by-flooders is again guided in the direction of the center of the flooding squeegee edge 118.

The by-flooders 114, 116 each have one section 122, 124 arranged diagonally with respect to the printing direction and to the flooding direction respectively. As in the embodiment illustrated in FIG. 8, these sections 122, 124 are provided for overlapping with the diagonally arranged sections of the adjacent by-flooders. As a result of the arrangement selected in the embodiment according to FIG. 10, first, with a by-flooder set, starting from the flooding squeegee edge 118, at approximately 10°, which then changes into a diagonal section 122, 124 set still farther toward the outside, a space requirement can be obtained which is small viewed in the printing direction, while the evacuation effect is simultaneously very good.

As in the embodiment of the flooding squeegee 84a shown in FIG. 8, in the case of the flooding squeegee 112, a feeding pipe for printing ink and a printing squeegee 120 are also provided. Analogous to FIG. 7, several flooding squeegees 112 with respectively assigned printing squeegees 120 would be arranged side-by-side in order to achieve a so-called multiple use.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A machining line for plate-type elements comprising at least one machining station and a positioning station for aligning the plate-shaped elements relative to a reference point with a predefined positioning tolerance, wherein
the positioning station is connected to an input side of the machining station in a material flow direction, and includes conveying devices for moving the plate-type elements from the positioning station to the machining station while maintaining the predefined position tolerance.

2. A machining line according to claim 1, wherein the conveying devices include at least a first conveyor belt assigned to the positioning station and a second conveyor belt assigned to the machining station, and suction devices for generating a vacuum in the area of the first conveyor belt and the second conveyor belt.

3. A machining line according to claim 1, wherein devices are provided for synchronizing the first and second conveyor belts at least during transfer of a plate-shaped element from the positioning station to the machining station.

4. A machining line according to claim 1, wherein the first and second conveyor belts have areas extending transversely to a running direction in which vacuum can be generated for securing a plate-shaped element, and the first and the second conveyor belts are arranged relative to one another such that during transfer of a plate-shaped element from the first conveyor belt to the second conveyor belt, at most one third of a length of the plate-shaped element situated parallel to the conveying direction is situated outside the areas of the first and second conveyor belts in which the vacuum is generated.

5. A machining line according to claim 4, wherein when viewed transversely to the material flow direction, a plurality of plate-shaped elements are arranged side-by-side and, simultaneously aligned in the positioning station, are transferred to the machining station and machined in the machining station.

6. A machining line according to claim 1, wherein the positioning station has at least one stop for aligning the plate-type elements.

7. A machining line according to claim 1, wherein the positioning station has at least two mutually opposite stops which can be moved toward one another and away from one another by means of a crankshaft and connecting rods.

8. A machining line according to claim 7, wherein, by means of its axis of rotation, the crankshaft intersects a central point of a predefined position of a plate-shaped element in the positioning station.

9. A machining line according to claim 7, wherein at least four stops are assigned to the crankshaft, said stops being arranged opposite one another in pairs and are, in each case, connected with the crankshaft by means of connecting rods.

10. A machining line according to claim 2, wherein the first conveyor belt assigned to the positioning station has devices for generating an air cushion below a plate-type element.

11. A machining line according to claim 1, wherein, in the area of the positioning station, devices are provided for generating an air current and, by means of the air current, at least one motive force is producible which acts upon the plate-type elements parallel and transversely to a conveying direction.

12. A machining line according to claim 2, wherein the first conveyor belt can be sloped to a material flow plane.

13. A machining line according to claim 1, wherein the machining station is constructed as a screen printing station.

14. A machining line according to claim 1, having at least one machining station constructed as a screen printing station, wherein, when viewed transversely to the material flow direction, a plurality of printing positions for one plate-type element respectively are arranged side-by-side in the screen printing station, and a separate printing squeegee is assigned to each printing position.

15. A machining line according to claim 14, wherein a common squeegee bar is provided which spans the printing positions arranged side-by-side and with which several printing squeegees are connected.

16. A machining line according to claim 15, wherein each printing squeegee is connected with the squeegee bar by means of at least two motion elements.

17. A machining line according to claim 16, wherein a separate respective regulating unit is assigned to each motion element of the printing squeegee.

18. A machining line according to claim 16, wherein the motion elements of each printing squeegee can be triggered separately.

19. A machining line according to claim 16, wherein the motion elements can be triggered as a function of an output signal of at least one sensor for detecting damage to a plate-type element.

20. A machining line according to claim 14, wherein a flooding squeegee is assigned to each printing squeegee, the flooding squeegee having a flooding squeegee edge extending transversely to a printing direction and having lateral by-flooders extending in each case from one end of the flooding squeegee end in the direction of the printing squeegee.

21. A machining line according to claim 20, wherein the by-flooders are arranged at an angle of between 90° and 110° with respect to the flooding squeegee edge.

22. A machining line according to claim 20, wherein the by-flooders extend at least to the printing squeegee.

23. A machining line according to claim 20, wherein the by-flooders have sections which at least partially extend diagonally to the printing direction, such sections of adjacent by-flooders overlapping in the projection viewed parallel to the printing direction.

24. A machining line according to claim 14, wherein, in the screen printing station, at least two screen hold-down devices are provided which extend approximately to a level of a printing squeegee edge.

25. A machining line according to claim 24, wherein, when viewed in a printing direction, the screen hold-down devices are arranged on the right and the left respectively of the several printing squeegees.

26. A machining line according to claim 1, wherein at least one of the positioning station and the machining station are equipped with a carrying frame that is arranged to be removable from the machining line transversely to the material flow direction.

27. A machining line according to claim 1, wherein the machining station has at least one hot air fan by which locally limited sites on the plate-shaped element can be acted upon.

28. A machining line according to claim 1, wherein the machining station is equipped with a movable printing table in order to move a plate-type element deposited on the printing table into a machining position.

29. A machining line according to claim 28, wherein the printing table is equipped with a conveyor belt extending over the printing table.

30. A process for machining plate-type elements in a production line, said process comprising the acts of:
positioning at least two plate-type elements arranged side-by-side viewed in a material flow direction with a predefined position tolerance in a positioning station,
conveying the at least two plate-type elements to a machining station by means of conveying devices while maintaining the predefined position tolerance, and
machining the at least two plate-type elements in the machining station.

31. A process according to claim 30, further comprising generating a vacuum and drawing the plate-type elements onto the conveying devices at least during the conveying and machining of the plate-type elements.

32. Process according to claim 30, further comprising generating an air cushion below the plate-type elements during the positioning.

33. A process according to claim 30, further comprising
detecting possible damage to the plate-type elements in at least one of the positioning station and the machining station immediately after the conveying of the plate-type elements, and
as a function of the detected damage to the plate-type elements, machining or not machining the plate-type elements in the machining station.

34. A process according to claims 30, further comprising
detecting possible damage to the plate-type elements, and, as a function of the detected damage, sorting out the damaged plate-type elements, a vacant position created by the sorting-out not being filled in the further course of the machining in the machining line.

35. A process according to claim 30, further comprising
positioning at least two plate-type elements side-by-side in a material flow direction,
detecting possible damage to the plate-type elements, and
as a function of the detected damage to the plate-type elements, machining or not machining the plate-type elements in the machining station, wherein the machining station is a screen printing station.

36. A machining line according to claim 16, wherein the motion elements are pneumatic pressure cylinders.

37. A machining line according to claim 17, wherein the regulating unit is a pneumatic pressure regulator.

38. A machining line according to claim 21, wherein the by-flooders are arranged at an angle of 100° with respect to the flooding squeegee edge.

39. A machining line according to claim 29, wherein the conveyor belt is a paper belt.
